(19) United States
(12) Patent Application Publication
(10) Pub. No.: US 2011/0027607 A1
(43) Pub. Date: Feb. 3, 2011

(54) MAGNESIUM HYBRID PARTS AND PROCESSES

(75) Inventors: Wojciech Krzewinski, Mississauga (CA); Ben Reginella, Bradford (CA); Matthew M. McNutt, Lapeer, MI (US); Anca Matache, Grosse Pointe Woods, MI (US)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(73) Assignees: Magna Seating Inc., Aurora (CA); Matcor-Matsu USA Inc., Madison Heights, MI (US)

(21) Appl. No.: 12/840,486

(22) Filed: Jul. 21, 2010

Related U.S. Application Data
(60) Provisional application No. 61/229,838, filed on Jul. 30, 2009.

(51) Int. Cl. B32B 3/10; B32B 15/04; B32B 15/18; B22D 19/00

(52) U.S. Cl. 428/596; 428/615; 428/649; 428/684; 164/98

(57) ABSTRACT

A light weight alloy part is molded in a mold containing at least one weldable metal insert, so that portions of portions of the alloy part lap portions of the insert to securely lock the weldable insert to the light weight alloy part. The resulting hybrid part is thus both light weight and weldable to other assemblies and sub-assemblies.

### CROSS-REFERENCE TO RELATED APPLICATIONS

This application claims priority from U.S. Patent Application Ser. No. 61/229,838, filed Jul. 30, 2009.

### BACKGROUND OF THE INVENTION

1. Technical Field

The present invention relates to the manufacture of light weight parts for assembly with other parts. Such parts are frequently used in airplanes and vehicles.

2. Background Art

British Patent 686,428 issued in 1954 discloses riveting strips of steel sheet metal to elongated aluminum-magnesium alloy profiled bearers. Steel sheet metal is welded to the strips of steel sheet metal.

Mellis et al., U.S. Patent Application Publication No. 2007/0271793, published Nov. 29, 2007 discloses a suspension arm for use in a vehicle, in which a coupling for assembling the arm to other components of the vehicle is attached to a tubular member made of steel, aluminum or the like, using a cast-in-place technique, rather than conventional welding.

### SUMMARY OF THE INVENTION

In the present invention, a light weight alloy part is molded in a mold containing at least one weldable metal insert, so that portions of portions of the alloy part lap portions of the insert to securely lock said weldable insert to the light weight alloy part. The resulting hybrid part is thus both light weight and weldable to other assemblies and sub-assemblies.

These and other objects, advantages and features of the invention will be more fully understood and appreciated by reference to the written specification and drawings.

### BRIEF DESCRIPTION OF THE DRAWINGS

FIG. 1 is a perspective and relatively close-up view of a known steering column support bracket, with the bracket being stamped and MIG-welded to the tubular member of an instrument panel frame;

FIG. 2 is a perspective view of an embodiment of a hybrid assembly consisting of a steel instrument panel frame and steering column support bracket comprising a magnesium-casted part and a steel insert assembly;

FIG. 3 is a perspective view of the steering column support bracket illustrated in FIG. 2;

FIG. 4 is a perspective view of the steering column support bracket shown in FIG. 2, and illustrating the location of the holes or forms within the steel stampings positioned below the magnesium line;

FIG. 5 is a perspective view showing the separate components of the steel inserts of the steel stampings of the steering column support bracket; and

FIG. 6 is a perspective and stand-alone view of the magnesium-casted component of the steering column support bracket.

### DETAILED DESCRIPTION OF THE INVENTION

The principles of a preferred embodiment are disclosed, by way of example, in a vehicle part 200 as described herein and illustrated in FIGS. 2-6. The vehicle part 200 includes components comprised of steel and of magnesium, with the use of magnesium facilitating a relative reduction in weight. The structure of the vehicle part 200 and preferred processes for manufacturing the vehicle part 200 permit the use of welding processes, although magnesium components are known to be essentially unweldable to other parts.

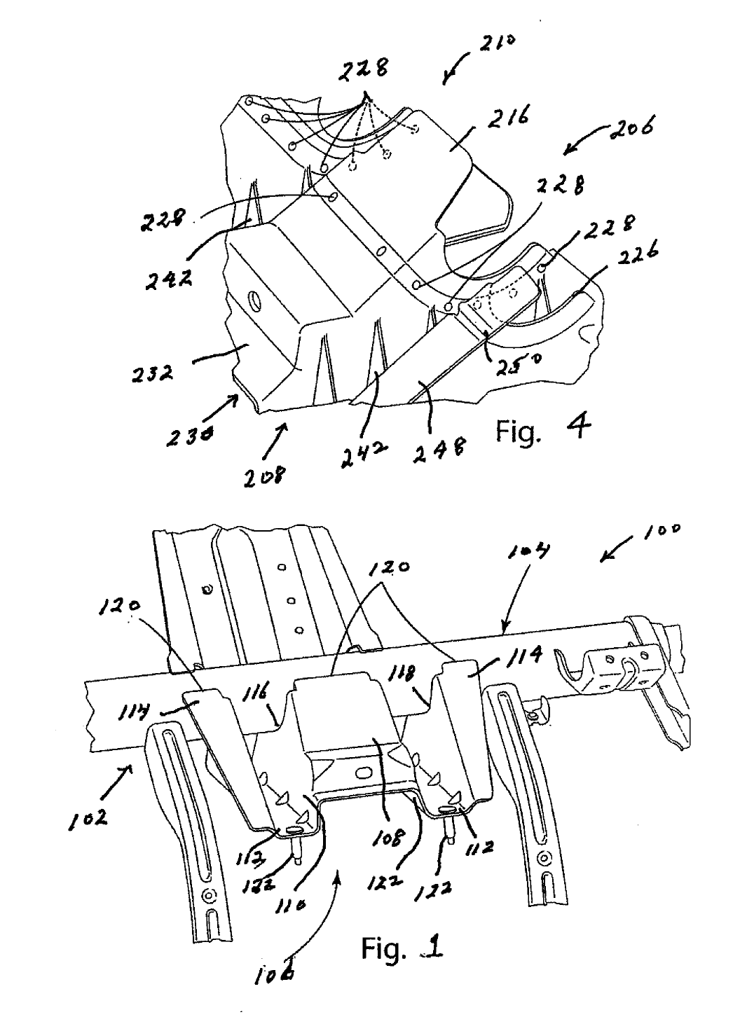

FIG. 1 illustrates a known vehicle part 100. The known vehicle part 100 can be characterized as an instrument panel reinforcement frame with a steering column support bracket. More specifically, the vehicle part 100 includes an instrument panel reinforcement frame or main frame 102 having a configuration as shown in part in FIG. 1. A greater portion of the main frame 102 is illustrated in FIG. 2 as frame 202, which incorporates the preferred embodiment and will be described in subsequent paragraphs herein. The main frame 102 includes a tubular member 104 which extends across the entirety of the upper portion of the main frame 102.

Secured to the tubular member 104 of the main frame 102 is a steering column support bracket 106. The known steering column support bracket 106 includes an upper or top plate 108 having a substantially rectangular configuration as illustrated in FIG. 1. Extending downwardly from opposing sides of the upper plate 108 are a pair of downwardly extending flanges 110. The downwardly extending flanges 110 can be integral with or otherwise secured to a pair of webs 112. In turn, the webs 112, at their edges opposing the edges adjacent the downwardly extending flanges 110, are coupled to or are integral with a pair of wings 114. For purposes of mating the steering column support bracket 106 to the tubular member 104, the downwardly extending flanges 110 each include an arcuate cut 116 having a shape conforming to the curvature of the outer surface of the tubular member 104. In addition, each of the wings 114 also includes an edge having an arcuate cut 118. Again, the arcuate cuts 118 are shaped to as to conform to the curvature of the tubular member 104. With the arcuate cuts 116, 118, the elements of the steering column support bracket 106 securely mate with the tubular member 104 of the main frame 102. FIG. 1 also illustrates a pair of bolts 122 which can be used to secure the steering column support bracket 106 to other components of the steering column itself.

For purposes of securing the steering support bracket 106 to the tubular member 104, the support bracket 106 can be directly welded to the tubular member 104, through MIG welding and resistance welding processes. Weld lines for the support bracket 106 and the tubular member 104 are shown as lines 120 in FIG. 1.

As previously described, the known vehicle part 100 includes the steering bracket support column 106 which is comprised of steel or steel alloys, and which are of relatively substantial weight. To reduce the weight and still permit the use of welding processes to secure a support bracket to a main frame in the manufacture of the vehicle part, the preferred embodiment 200 illustrated in FIGS. 2-6 provides for a relatively lighter weight steering column support bracket, while still permitting the use of welding processes in the manufacture of the entirety of the vehicle part.

The preferred embodiment comprised of the vehicle part 200 is specifically shown in FIGS. 2-6. As apparent from subsequent description, a number of the components of the vehicle part 200 correspond to the components of the vehicle part 100 with respect to the main frame. In fact, one of the advantages of the preferred embodiment is the addition of a relatively lighter weight magnesium part into the assembly of the steering column support bracket and main frame, without substantial modification to the assembly process. That is, the steering column support bracket in accordance with the preferred embodiment will still be MIG welded to components of the main frame.

More specifically, and with respect to FIGS. 2-6, the vehicle part 200 includes a main frame 202, shown substantially in its entirety in FIG. 2. The main frame 202, in this particular embodiment, is shown as an instrument panel reinforcement frame. However, it should be emphasized that numerous parts can be manufactured in accordance with processes associated with the preferred embodiment, other than the specific main frame and steering column support bracket described herein.

The main frame 202 includes a tubular member 204 extending substantially along the entirety of the length of the main frame 202. Secured to the tubular member 204 of the main frame 202, through welding processes, is a steering column support bracket 206. The steering column support bracket 206, when assembled with the main frame 202, performs the same functions as the steering column support bracket 106 previously described with respect to the vehicle part 100. However, unlike the steering column support bracket 106, the steering column support bracket 206 of the preferred embodiment comprises a magnesium part 208 which is molded to weldable steel inserts 210. The magnesium part 208 is shown in a perspective and stand-alone configuration in FIG. 6. In accordance with the preferred embodiment, the magnesium part 208 is of a relatively lighter weight than steel components, and is the principle part of the assembly, the weldable steel inserts being smaller. Yet, the weldable steel inserts are sufficiently large as to space the magnesium part 208 sufficiently far from the welder to avoid igniting the magnesium during the welding process.

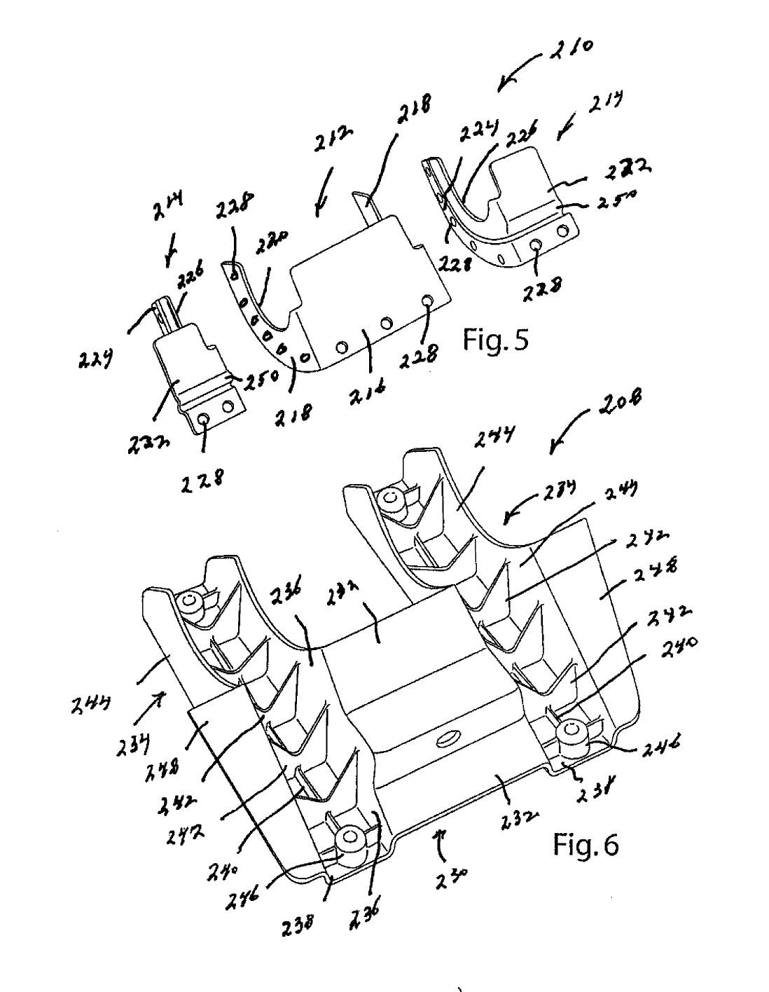

In addition to the magnesium part 208, the steering column support bracket 206 also includes steel inserts 210. The steel inserts 210 are also shown in a perspective and stand-alone configuration in FIG. 5. As illustrated therein, the steel inserts 210 can include three inserts. The inserts are shown as center insert 212 and a pair of opposing side inserts 214.

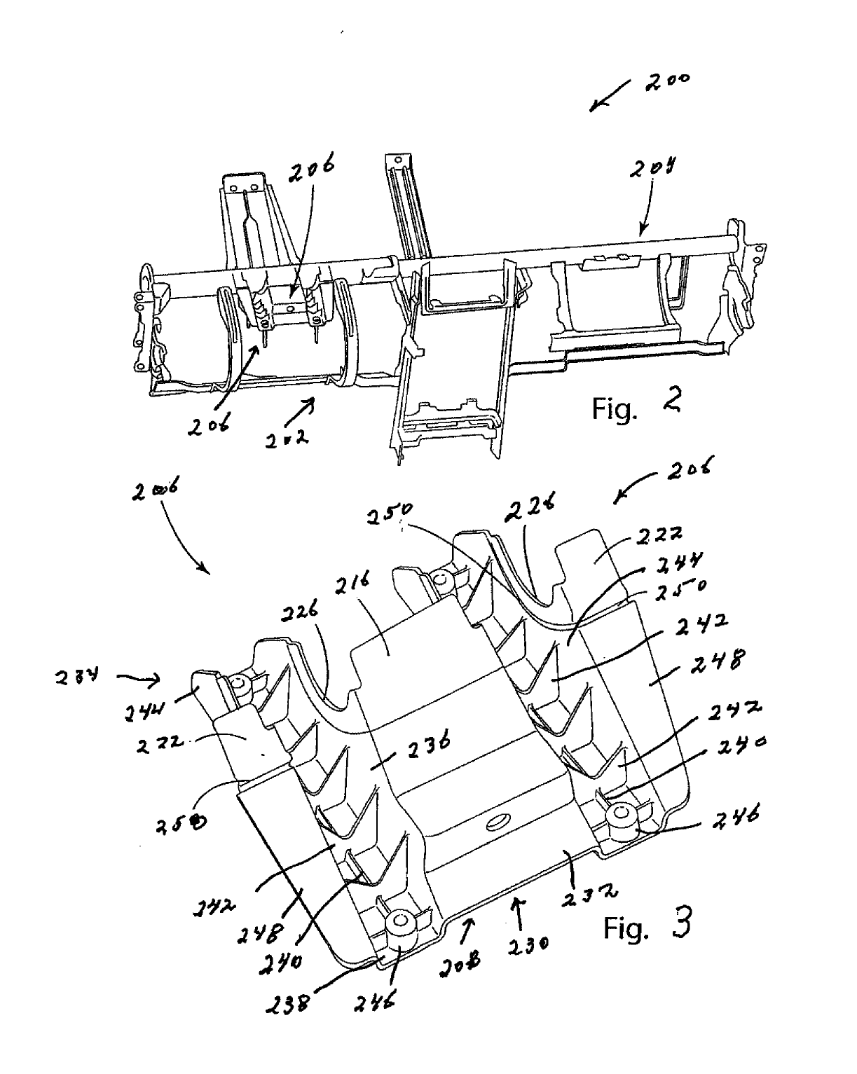

With respect to the center insert 212, and as shown particularly in FIGS. 3, 4 and 5, the insert 212 includes a substantially rectangular top plate 216. A pair of extending flanges 218 extend downwardly from the top plate on opposing sides thereof. The downwardly extending flanges 218 each include an arcuate cut 220 having a shape and configuration as primarily shown in FIG. 5. The shape and configuration of the arcuate cut 220 will conform to the curvature of the tubular member 204 for purposes of mating the components together.

Turning to the side inserts 214, each side insert 214 is comprised of an outwardly extending steel wing 222. The steel wings 222 are shown in detail primarily in FIG. 5. Each of the outwardly extending steel wings 222 includes a downwardly extending flange 224. Each downwardly extending flange 224 includes an arcuate cut 226. The arcuate cuts 226, as with the arcuate cuts 220, are also shaped so as to conform to the curvature of the tubular member 204. In addition, and as will be apparent from subsequent description herein, the shape and configuration of the downwardly extending flanges 218 and 224 will conform to shapes and configurations of elements of the magnesium part 208 described subsequently herein.

Reference is now made to FIGS. 4 and 5, showing the elements of the steel inserts 210. As shown therein, the center insert 212 and side inserts 214 all include a series of holes 228 positioned at various locations on the inserts 210. More specifically, and primarily with reference to FIG. 5, three holes 228 are shown within the top plate 216. A pair of holes 228 are shown in a top portion of each of the outwardly extending steel wings 222. Further, holes 228 are positioned through the downwardly extended flanges 218 of the center insert 212, and the downwardly extending flanges 224 of the side inserts 214. In manufacture of the vehicle part 200, the holes 15 will allow molten magnesium to flow from one side of a steel insert 210 to the other side thereof. When the magnesium hardens, the hardening action will serve to lock the steel inserts 210 in place, with respect to the magnesium part 208. Without this locking function, the magnesium, in view of its properties, would not bond to the steel of the steel inserts 210 to any significant degree.

Reference is now made primarily to FIG. 6, showing a stand-alone configuration of the magnesium part 208. The magnesium part 208 includes, in this particular embodiment, a center portion 230 and a series of plates 232 at various angled configurations relative to one another. Positioned outwardly relative to the center portion 230 are a pair of extending members 234, which extend from a front to a rear of the steering column support bracket 206. Each of the extending members 234 includes an inner and downwardly extending flange 236 which can be integral with the sides of the plates 232. At the bottom of the inner downwardly extending flanges 236 is a lower section 238 which can be positioned substantially at a right angle with respect to the corresponding flange 236. Positioned on the lower sections 238 are a set of strengthening ribs 240 which extend from the front to the rear of the magnesium part 208. A series of webs 242, again for strengthening purposes, are positioned transversely across the ribs 240. Extending upwardly from the lower sections 238 are a pair of outer flanges 244. The magnesium part 208 can also include a set of formed bushings 246, for purposes of receiving connecting components for securing the steering column support bracket 206 to other components of the steering column.

FIG. 3 illustrates a stand-alone, perspective view of the entirety of the steering column support bracket 206, specifically showing the magnesium part 208 and the steel inserts 210. The steel inserts 210 can be formed through conventional stamping processes. The magnesium part 208 can be formed as a casting through injection molding processes. During the molding processes, the steel inserts 210, appropriately positioned with respect to the magnesium part molding configuration, are insert molded and over-molded.

To appropriately secure the steel inserts 210 to the magnesium part 208, the previously described holes 228 are positioned relative to the mold for the magnesium part 208, so that the holes 228 in the top plate 216 and in the upper portions of the outwardly extending steel wings 222 are located below the center portion 230 and the outwardly extending wings 248 of the magnesium part 208. When in these positions, and also with respect to the holes 228 located in the flanges 218 and 224 of the steel inserts 210, the holes 228 will permit molten magnesium injected into the mold to flow from one side of each of the steel inserts 210 to the other side. When the molten magnesium hardens, the resultant steering column support bracket 206 will have the configuration as particularly shown in FIGS. 3 and 4. As apparent from the relative positioning of the steel inserts 10 and the magnesium part 208 as shown in these drawings, the steel inserts 210 are essentially locked in place relative to the magnesium part 208. This function permits the steel inserts 214 to be coupled to the magnesium part 208, without any use of welding or other connecting processes which are difficult to achieve with magnesium and similar metals.

In addition to the advantageous functions of the holes 228, another aspect of the preferred embodiment for the vertical part 200 is the use of a series of beads 250. The beads 250 are particularly shown in FIGS. 3 and 5 and are located on the steel inserts 210. More specifically, the beads 250 can be characterized as being located at each position where there is a junction between a portion of the magnesium part 208 and a portion of the steel inserts 210 of the support bracket 206. When the steel inserts 210 are positioned in the injection mold, and the molten magnesium is injected into the mold, the beads 250 serve to substantially prevent any molten magnesium from covering surfaces of the steel inserts which need to be exposed for purposes of facilitating welding of the steel inserts to the tubular member 204.

Certain other aspects of the preferred embodiment and other embodiments can also be described. With respect to the holes 228, it should be noted that the holes 228 can take other shapes and configurations within the steel inserts 210. Of primary importance is that the holes or other formations in the steel inserts are positioned below what could be characterized as the “magnesium line” so as to allow the magnesium to flow through the holes or other formations during the molding stage, for purposes of effectively locking the steel inserts 210 to the magnesium part 208.

With the steel inserts 210 forming part of the steering column support bracket 206, the support bracket 206 can still be welded to the tubular member 204 or other components of the main frame 202. That is, although the preferred embodiment advantageously utilizes a magnesium part 208 for the support bracket 206, the use of the steel inserts 210 still provide the capability of welding (such as by MIG welding or resistance welding) the bracket 206 to the main frame 202. Accordingly, the general process of assembling the steering column support bracket 206 to the main frame 202 is not substantially changed in that the bracket 206 is still welded to the tubular member 204.

It is also possible to achieve the advantages of the embodiment, while having a differing relative configuration of the steel inserts 210 and the magnesium part 208. For example, at least part of the steel inserts 210 could be positioned in other locations relative to the magnesium part 208 and the entirety of the support bracket 206. That is, at least part of the steel inserts 210 could be positioned in the middle of the entirety of the support bracket 206, with openings positioned within the magnesium part 208. Such a configuration would allow for the capability of more extensive welding positions.

The steel utilized for the steel inserts 210 can be one of a number of variations. For example, it is believed that any 1008-1020 hot rolled, cold rolled or plate steel may be utilized for the steel inserts 210. It may also be possible to utilize aluminum. However, a potential difficulty with the use of aluminum is that distortion must be avoided.

Also, it should be emphasized that the preferred embodiment described herein is directed specifically to a main frame 202 and steering column support bracket 206. It is clear from the foregoing description that the advantageous processes associated with the preferred embodiment may be used for various types of structural components, in vehicles and for other purposes.

It will be apparent to those skilled in the pertinent arts that other embodiments of hybrid parts and processes associated with manufacture thereof can be designed. That is, the principles of hybrid parts and processes for manufacture are not limited to the specific embodiment described herein. Accordingly, it will be apparent to those skilled in the art that modifications and other variations of the above-described illustrative embodiment may be effected without departing from the spirit and scope of the novel concepts of the embodiment.

What is claimed is:

1. A hybrid part for structural uses, comprising:
a first metal insert comprising a weldable first material, and adapted to be connected to separate structures through one or more welding processes;
a second part comprising a second material having a relatively low weldability and also having a lower density than said first material; and
said first metal insert is securely locked in place relative to said second part through portions of said second material being formed to lap portions of said first metal insert.

2. A hybrid part in accordance with claim 1, characterized in that said first metal insert comprises a plurality of apertures positioned relative to said second part so as to receive a flow of a portion of said second material, when said second material is in a molten state.

3. A hybrid part in accordance with claim 1, characterized in that said first metal insert comprises one or more beads formed on surfaces of said first metal insert and positioned so as to prevent any of said second material from covering surfaces of said first metal insert which need to be exposed for purposes of facilitating welding of said first metal insert to said separate structures.

4. A hybrid part in accordance with claim 1, characterized in that said second material is magnesium.

5. A hybrid part in accordance with claim 1, characterized in that said weldable first material is a steel.

6. A hybrid part in accordance with claim 1, characterized in that said first metal insert comprises:
a plurality of apertures extending through portions of said first metal insert for receiving portions of said second material, when said portions are in a molten state; and
a plurality of beads formed on surfaces of said first metal insert and positioned so as to prevent other portions of said second material from covering surfaces of said first metal insert which need to be exposed for purposes of facilitating welding of said first metal insert to said separate structures.

7. A hybrid part in accordance with claim 6, characterized in that said first metal insert further comprises:
a center insert section having a top plate and extending flanges downwardly extending from opposing sides of said top plate, with said center insert having a subset of said plurality of apertures; and
a pair of opposing side insert sections, each of said side insert sections having a downwardly extending flange and outwardly extending steel wings, and further having a second subset of said plurality of apertures.

8. A method for forming a hybrid part for structural uses, comprising:
providing a first metal insert comprising a weldable first material, and adapted to be connected to separate structures through one or more welding processes, and placing said insert into a mold;
molding a second part, comprising a second material having a relatively low weldability and also having a lower density than said first material, in said mold so that portions of said second part lap portions of said insert to securely lock said first metal insert to said second part.

9. The method in accordance with claim 8, characterized in that said first metal insert comprises a plurality of apertures positioned relative to said second part so as to receive a flow of a portion of said second material, when said second material is in a molten state.

10. The method in accordance with claim 8, characterized in that said first metal insert comprises one or more beads formed on surfaces of said first metal insert and positioned so as to prevent any of said second material from covering surfaces of said first metal insert which need to be exposed for purposes of facilitating welding of said first metal insert to said separate structures.

11. The method in accordance with claim 8, characterized in that said second material is magnesium.

12. The method in accordance with claim 8, characterized in that said weldable first material is a steel.

13. The method in accordance with claim 8, characterized in that said first metal insert comprises:
a plurality of apertures extending through portions of said first metal insert for receiving portions of said second material, when said portions are in a molten state; and
a plurality of beads formed on surfaces of said first metal insert and positioned so as to prevent other portions of said second material from covering surfaces of said first metal insert which need to be exposed for purposes of facilitating welding of said first metal insert to said separate structures.

14. The method in accordance with claim 13, characterized in that said first metal insert further comprises:
a center insert section having a top plate and extending flanges downwardly extending from opposing sides of said top plate, with said center insert having a subset of said plurality of apertures; and
a pair of opposing side insert sections, each of said side insert sections having a downwardly extending flange and outwardly extending steel wings, and further having a second subset of said plurality of apertures.
